(19) United States
(12) Patent Application Publication
(10) Pub. No.: US 2013/0097364 A1
(43) Pub. Date: Apr. 18, 2013

(54) NONVOLATILE MEMORY DEVICE AND RELATED METHOD OF OPERATION

(71) Applicants: KYOUNG-LAE CHO, YONGIN-SI (KR); JAE-HONG KIM, SEOUL (KR); JUN-JIN KONG, YONGIN-SI (KR)

(72) Inventors: KYOUNG-LAE CHO, YONGIN-SI (KR); JAE-HONG KIM, SEOUL (KR); JUN-JIN KONG, YONGIN-SI (KR)

(73) Assignee: SAMSUNG ELECTRONICS CO., LTD., SUWON-SI (KR)

(21) Appl. No.: 13/608,004

(22) Filed: Sep. 10, 2012

(30) Foreign Application Priority Data
Oct. 17, 2011 (KR) 10-2011-0105971

(51) Int. Cl. G06F 12/00

(52) U.S. Cl. 711/103; 711/E12.008

(57) ABSTRACT

A method of operating a nonvolatile memory device comprises defining a bit ordering for a plurality of n-bit (n>2) multi-level cells such that bit-reading numbers associated with different pages of the n-bit multi-level cells are substantially equalized, wherein the bit ordering assigns at least one bit “0” to an erased state of the n-bit multi-level cells, and programming n-bit data into each of the n-bit multi-level cells according to the bit ordering.

### CROSS-REFERENCE TO RELATED APPLICATIONS

This application claims priority under 35 U.S.C. §119 to Korean Patent Application No. 10-2011-0105971 filed on Oct. 17, 2011, the subject matter of which is hereby incorporated by reference.

### BACKGROUND OF THE INVENTION

The inventive concept relates generally to electronic memory technologies. More particularly, the inventive concept relates to nonvolatile memory devices capable of storing multi-bit data and related methods of operation.

Nonvolatile memory devices retain stored data even when disconnected from power. Accordingly, they are commonly used to provide long term data storage in a wide variety of electronic devices, such as personal computers (PCs), mobile phones, tablets, digital cameras, and many others.

There is a general demand for nonvolatile memory devices having relatively large storage capacity and fast performance. One way that researchers have attempted to provide large storage capacity is by designing nonvolatile memory devices capable of storing more than one bit in each of its memory cells. Such devices are commonly referred to as multi-level cell (MLC) memory devices.

An MLC memory device typically stores data by setting a memory cell to one of various states corresponding to different bit values. For instance, an n-bit memory cell may have 2ⁿ different states representing different bit values. In a more specific example, a 3-bit memory cell may have first through eighth states corresponding to respective bit values “000”, “001”, “010”, “011”, “100”, “101”, “110”, and “111”.

In general, the assignment of different bit values to different memory cell states is referred to as bit ordering. As an example, the eight states in the above-described 3-bit memory cell could alternatively be assigned to respective bit values “000”, “001”, “011”, “010”, “110”, “111”, “101”, “100”. This example uses gray coding (or gray ordering) so that each memory cell state differs by only one bit from each adjacent memory cell state. This can potentially simplify the process of storing different bit values, and it can also minimize the number of errors that occur when memory cells unintentionally transition between adjacent memory cells.

In various alternative devices, different bit ordering schemes can be used to obtain performance advantages. Accordingly, bit ordering is of general concern to researchers striving to improve the performance of nonvolatile memory devices.

### SUMMARY OF THE INVENTION

According to an embodiment of the inventive concept, a method of operating a nonvolatile memory device comprises defining a bit ordering for a plurality of n-bit (n>2) multi-level cells such that bit-reading numbers associated with different pages of the n-bit multi-level cells are substantially equalized, wherein the bit ordering assigns at least one bit “0” to an erased state of the n-bit multi-level cells, and programming n-bit data into each of the n-bit multi-level cells according to the bit ordering.

According to another embodiment of the inventive concept, a memory system comprises a nonvolatile memory comprising a plurality of n-bit (n>2) multi-level cells, and a controller configured to program n-bit data into the n-bit multi-level cells according to a bit ordering in which bit-reading numbers associated with different pages of the n-bit multi-level cells are substantially equalized and in which at least one bit “0” is assigned to an erased state of the n-bit multi-level cells.

These and other embodiments can potentially reduce the number of read operations required to access data stored in multi-bit memory cells. The reduced number of read operations can potentially reduce the amount of overhead used to perform error correction.

### BRIEF DESCRIPTION OF THE DRAWINGS

The drawings illustrate selected embodiments of the inventive concept. In the drawings, like reference numbers indicate like features.

FIG. 1 is a flowchart illustrating a method of storing data in a nonvolatile memory device according to an embodiment of the inventive concept.

FIG. 2 is a diagram illustrating an example bit ordering that can be used for 3-bit multi-level cells in the method of FIG. 1.

FIG. 3 is a diagram illustrating a relationship between states of the 3-bit multi-level cells and pages, which that are data read-out units.

FIG. 4 is a diagram illustrating bit errors that may be generated when data stored in the 3-bit multi-level cells is read according to the bit ordering of FIG. 2.

FIGS. 5A through 5C are diagrams illustrating operations for reading data stored in 3-bit multi-level cells using the bit ordering of FIG. 2.

FIG. 6 is a table illustrating bit errors and bit-reading numbers in pages of 3-bit multi-level cells read by the operations of FIGS. 5A through 5C.

FIG. 7 is a diagram illustrating another example bit ordering that can be used for 3-bit multi-level cells in the method of FIG. 1.

FIG. 8 is a diagram illustrating another example bit ordering that can be used for 3-bit multi-level cells in the method of FIG. 1.

FIG. 9 is a diagram illustrating an example bit ordering that can be used for 4-bit multi-level cells in the method of FIG. 1.

FIGS. 10A through 10D are diagrams illustrating operations for reading data stored in the 4-bit multi-level cells using the bit ordering of FIG. 9.

FIG. 11 is a table illustrating bit errors and bit-reading numbers in pages of the 4-bit multi-level cells read by the operation of FIGS. 10A through 10D.

FIG. 12 is a diagram illustrating another example bit ordering that can be used for 4-bit multi-level cells in the method of FIG. 1.

FIG. 13 is a block diagram of a memory system comprising a nonvolatile memory device that stores data according to the method of FIG. 1 according to an embodiment of the inventive concept.

FIG. 14 is a block diagram of a computing system comprising the memory system of FIG. 13 according to an embodiment of the inventive concept.

FIG. 15 is a block diagram illustrating a memory card in which data is stored according to the method of FIG. 1 according to an embodiment of the inventive concept.

FIG. 16 is a block diagram illustrating a solid state drive (SSD) in which data is stored according to the method FIG. 1 according to an embodiment of the inventive concept.

FIG. 17 is a diagram illustrating a server system comprising the SSD of FIG. 16 and a network system comprising the server system according to an embodiment of the inventive concept.

### DETAILED DESCRIPTION

Embodiments of the inventive concept are described below with reference to the accompanying drawings. These embodiments are presented as teaching examples and should not be construed to limit the scope of the inventive concept.

For convenience, certain embodiments are described in relation to a NAND flash memory. However, the inventive concept is not limited to NAND flash memory, and it can be applied to other forms of nonvolatile memory. Moreover, certain embodiments are described in relation to 3-bit and 4-bit multi-level cells. However, the inventive concept is not limited to these types of multi-level cells, and it can be applied generally to n-bit multi-level cells, where n is any integer greater than 2.

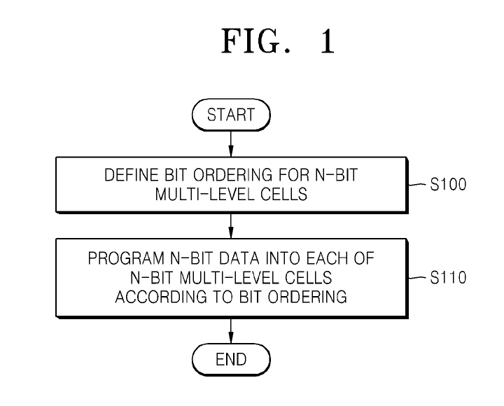

FIG. 1 is a flowchart illustrating a method of storing data in a nonvolatile memory device according to an embodiment of the inventive concept.

Referring to FIG. 1, the method comprises defining a bit ordering for n-bit multi-level cells (S100), and storing data in the n-bit multi-level cells according to bit ordering (S110). The bit ordering assigns at least one bit “0” to an erased state of each of the n-bit multi-level cells. For example, the bit ordering may assign a logical value “01” or “00” to the erased state, because these values each have at least one bit “0”. However, the bit ordering does not assign “11” to the erased state because this state does not have at least one bit “0”.

In a 3-bit multi-level cell, the bit ordering may assign any logical value, except “111”, from among “111”, “110”, “010”, “011”, “001”, “000”, “100”, and “101” to an erased state. The logical values not assigned to the erased state may be assigned to programmed states of the 3-bit multi-level cell. Similarly, in a 4-bit multi-level cell, the bit ordering may assign any logical value, except “1111”, to an erased state. The logical values not assigned to the erased state may be assigned to programmed states of the 4-bit multi-level cell.

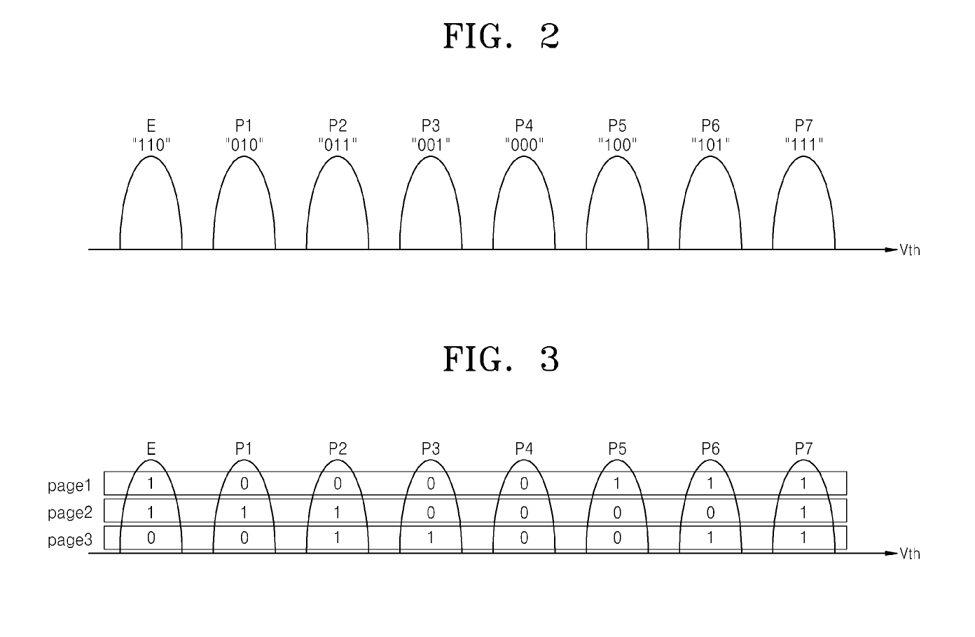

FIG. 2 is a diagram illustrating an example bit ordering that can be used for 3-bit multi-level cells in the method of FIG. 1.

Referring to FIG. 2, 3-bit multi-level cells store data using eight states E, P1, P2, P3, P4, P5, P6, and P7, where state E is an erased state and states P1 through P7 are programmed states. Each state corresponds to a threshold voltage range of the 3-bit multi-level cells. Intervals between the states may be set to be similar to one another in order to maintain constant changes in threshold voltages according to the states as program/erase cycles increase and a data storage time increases. Logical values are assigned to states E and P1 through P7 according to a bit ordering “110”, “010”, “011”, “001”, “000”, “100”, “101”, and “111”. The logical value “110” is assigned to erased state E and the other logical values “010”, “011”, “001”, “000”, “100”, “101”, and “111” are respectively assigned to programmed states P1 through P7.

Bits of the logical values representing 3-bit data may be programmed into the 3-bit multi-level cells. For example, 3-bit data comprising a most significant bit (MSB) “0”, a central significant bit (CSB) “1”, and a least significant bit (LSB) “0” is programmed into a 3-bit multi-level cell by changing its threshold voltage to a range corresponding to programmed state P1.

The bit ordering shown in FIG. 2 can be used to equalize the number of times that data is read from each of the three different bits of the 3-bit memory cells. This equalization will be explained in greater detail with reference to FIGS. 3 through 6.

FIG. 3 is a diagram illustrating a relationship between states of the 3-bit multi-level cells of FIG. 2 and pages, which are data read-out units. In other words, during read operations, a page of data is read out from a page of 3-bit multi-level cells. For example, in a NAND flash memory devices, a page of data is typically read out from memory cells connected to the same row. Because each memory cell stores 3-bit data, three different pages can be read from the row of memory cells. These pages can be, for instance, a least significant bit (LSB) page, a central significant bit (CSB) page, and a most significant bit (MSB) page.

Referring to FIG. 3, an LSB, a CSB, and an MSB of 3-bit data stored in the 3-bit multi-level cells are included in first through third pages page1 through page 3. For example, LSBs 1, 0, 0, 0, 0, 1, 1, and 1 of the data stored in a 3-bit multi-level cell corresponding to states E and P1 through P7 are included in first page page 1, CSBs 1, 1, 1, 0, 0, 0, 0, and 1 of the data stored in the 3-bit multi-level cell corresponding to states E and P1 through P7 are included in second page page 2, and MSBs 0, 0, 1, 1, 0, 0, 1, and 1 of the data stored in the 3-bit multi-level cell corresponding to states E and P1 through P7 are included in third page page 3. Accordingly, the LSBs, the CSBs, and the MSBs are read out in first page page 1, second page page 2, and third page page 3.

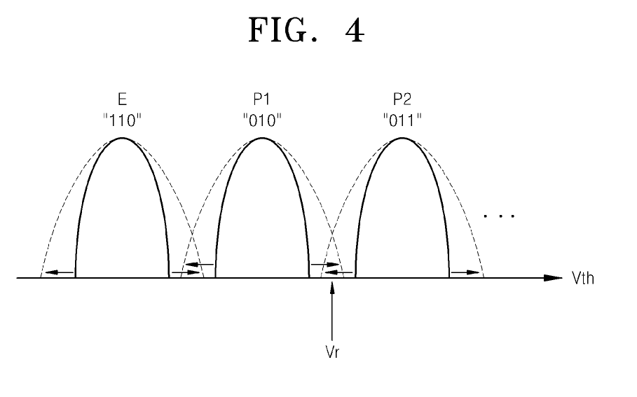

FIG. 4 is a diagram illustrating bit errors that may be generated when data stored in the 3-bit multi-level cells is read according to the bit ordering of FIG. 2.

The data is read out using a sensing circuit of a NAND flash memory comprising the 3-bit multi-level cells. The sensing circuit reads LSBs through MSBs based on a comparison between various read-out voltages and threshold voltage states of the 3-bit multi-level cells. The sensing circuit typically reads out the LSBs through the MSBs of the 3-bit data by continuously repeatedly applying another read-out voltage based on a result obtained after reading a previous page. To read the n-bit data stored in the n-bit multi-level cell in this manner, bits may need to be read at least 2ⁿ⁻¹ times. Also, to accurately compare a threshold voltage with a read-out voltage, intervals between threshold voltage ranges corresponding to states of the 3-bit multi-level cell should be reliable. For example, it should remain relatively stable or predictable.

Referring to FIG. 4, where a threshold voltage range corresponding to a state of the 3-bit multi-level cell is changed by a sufficient amount, as indicated by a dashed line, an overlapping region is generated between threshold voltage ranges corresponding to adjacent states. For example, where data is continuously repeatedly programmed/erased in a NAND flash memory and thus the NAND flash memory is close to an end of life (EOL), an overlapping region may be generated between threshold voltages ranges. Also, an overlapping region may be generated between threshold voltage ranges due to coupling between adjacent multi-level cells. Accordingly, an overlapping region may be generated between threshold voltage ranges corresponding to erased state E and programmed state P1 and between voltage voltages corresponding to programmed state P1 and programmed state P2. Although not shown in FIG. 4, an overlapping region may be generated between threshold voltage ranges corresponding to the other programmed states P3 through P7.

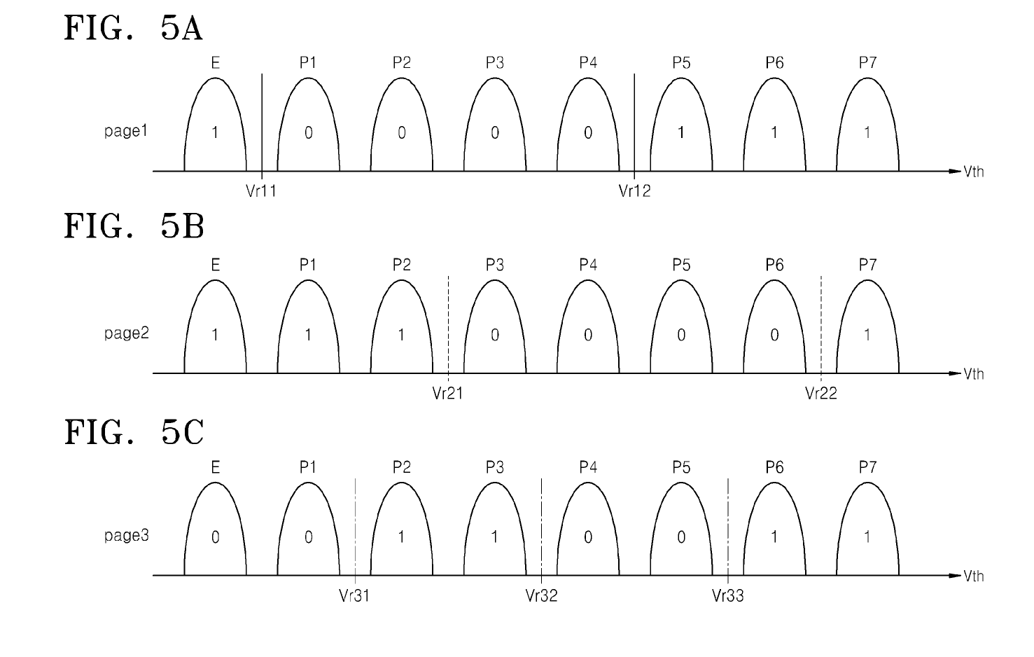

An error may be generated where overlapping regions between threshold voltage ranges are compared with a predetermined read-out voltage during a bit reading operation for the data stored in the 3-bit multi-level cell. For example, where an overlapping region between programmed state P1 and programmed state P2 is read with a read-out voltage Vr, bits corresponding to programmed state P1 or bits corresponding to programmed state P2 may be read out. The overlapping region can result in two types of errors, including one type where a memory cell is erroneously read as having programmed state P1, and another type where a memory cell is erroneously read as having programmed state P2. Such errors can occur each time a particular read-out voltage is used to distinguish between adjacent threshold voltage ranges. Accordingly, it may be advantageous to reduce the number of times that different threshold voltage ranges must be distinguished during a read operation in order to avoid such errors, as will be apparent from the description of FIGS. 5A through 5C.

FIGS. 5A through 5C are diagrams illustrating operations for reading data stored in 3-bit multi-level cells using the bit ordering of FIG. 2.

Referring to FIG. 5A, LSBs 1, 0, 0, 0, 0, 1, 1, and 1 of the data stored in 3-bit multi-level cells in a first page page 1 are read out through two bit reading operations. In particular, LSBs of the data stored in the 3-bit multi-level cell in first page page 1 are read out by reading a region between erased state E and programmed state P1 with a read-out voltage Vr11 and by reading a region between programmed states P4 and P5 with a read-out voltage Vr12.

Referring to FIG. 5B, CSBs 1, 1, 1, 0, 0, 0, 0, and 1 of the data stored in the 3-bit multi-level cells in second page page 2 are read out through two bit reading operations. In particular, CSBs of the data stored in the 3-bit multi-level cells in second page page 2 are be read out by reading a region between programmed states P2 and P3 with a read-out voltage Vr21 and reading a region between programmed states P6 and P7 with a read-out voltage Vr22.

Referring to FIG. 5C, the MSBs 0, 0, 1, 1, 0, 0, 1, and 1 of the data stored in the 3-bit multi-level cells in third page page 3 are read out through 3 bit reading operations. In particular, MSBs of the data stored in the 3-bit multi-level cells in third page page 3 are read out by reading a region between programmed states P1 and P2 with a read-out voltage Vr31, reading a region between programmed states P3 and P4 with a read-out voltage Vr32 and reading a region between programmed states P5 and P6 with a read-out voltage Vr33.

In the operations of FIGS. 5A through 5C, the bit ordering of FIG. 2 is used to reduce a total number of bit reading operations to 7. This equalizes differences between bit-reading numbers of each of first through third pages page 1 through page 3 to 0 or 1. For example, the first page page 1 and second page page 2 have the same number of bit reading operations, while third page page 3 has just one more bit reading operation than first and second pages page 1 and page 2.

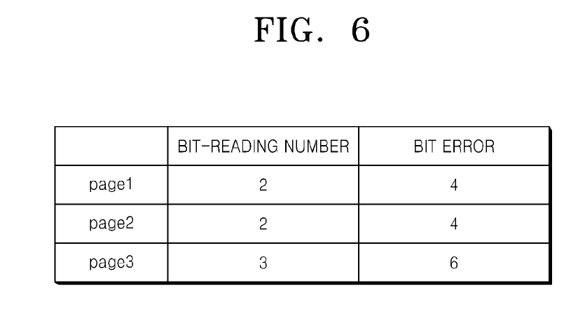

FIG. 6 is a table illustrating bit errors and bit-reading numbers in pages of 3-bit multi-level cells read by the operations of FIGS. 5A through 5C. More specifically, FIG. 6 shows the number of different types of bit errors that can occur when reading different pages of the 3-bit multi-level cells, and it also shows the number of bit reading operations performed when reading the different pages.

Referring to FIG. 6, when using the bit ordering of FIG. 2, the bit-reading numbers of different pages are equalized such that the bit-reading numbers in first page page 1, second page page 2, and third page page 3 are 2, 2, and 3, respectively. Because the bit-reading numbers and the bit errors are proportional to each other (see FIG. 4), four different types of bit errors can be generated in the reading of first page page 1, four different types of bit errors can be generated in the reading of second page page 2, and six different types of bit errors can be are generated in the reading of third page page 3.

A maximum number of bit errors generated during a data read operation using the bit ordering of FIG. 2 is less than that when using other bit orderings, such as gray coding. For example, in gray coding, there are two limitations when bits of a logical value are assigned to each state. First, only bit “1” is assigned to an erased state of a multi-level cell. For example, in a 2-bit multi-level cell, a logical value assigned to an erased state is “11”, and in a 3-bit multi-level cell, a logical value assigned to an erased state is “111”. Second, data programmed into a multi-level cell limits a pattern in which bits are changed between logical values of adjacent states of the multi-level cell. That is, where data is programmed, because the data may be programmed only to increase a threshold voltage, a pattern in which a threshold value range corresponding to each of adjacent states of the multi-level cell is reduced may not be used. Accordingly, the gray coding assigns logical values “111”, “110”, “100”, “101”, “001”, “000”, “010”, and “011” to states E and P1 through P7 of the 3-bit multi-level cell.

Where 3-bit data stored in the 3-bit multi-level cell is read out according to the gray coding, because LSBs 1, 1, 1, 1, 0, 0, 0, and 0 of the data stored in the 3-bit multi-level cell corresponding to states are in a first page page 1, one bit reading operation is needed. Because CSBs 1, 1, 0, 0, 0, 0, 1, and 1 of the data stored in the 3-bit multi-level cell corresponding to the states are in a second page page 2, two bit reading operations are needed. Because MSBs 1, 0, 0, 1, 1, 0, 0, and 1 of the data stored in the 3-bit multi-level cell corresponding to the states are in a third page page 3, four bit reading operations are needed. That is, when gray coding is used, bit-reading numbers increase twofold toward higher pages. Accordingly, 2, 4, and 8 different types of bit errors may be generated in different pages.

When using the bit ordering of FIG. 2, a maximum number of different types of bit errors that may occur during a read operation is 6, which is less than the 8 for gray coding. A page comprising bit errors may be corrected by using an error-correcting code (ECC). The ECC may be performed by a controller of a NAND flash memory, and an ECC condition needs to be designed to correct all errors in pages in order to improve ECC performance. That is, the ECC condition is set by considering a maximum number of bit errors in a page. Accordingly, where the bit ordering of FIG. 2 is used, an ECC condition may be set to correct fewer bit errors than those in a case where the gray coding is used, thereby making it easy to implement ECC hardware and software and reducing overhead of parity bits.

As a result, where data is stored in an n-bit multi-level cell using the method of FIG. 1, the number of bit-reading operations for different pages of a data read-out operation may be equalized and a maximum number of bit errors which are generated may be reduced, thereby reducing overhead required to perform error correction.

The bit ordering of FIG. 2 equalizes bit-reading numbers according to pages during a data read-out operation to {2, 2, 3}. In particular, the bit-reading numbers are 2 for first page page 1, 2 for second page page 2, and 3 for third page page 3. It is assumed below that the same expression indicates the bit-reading number in a corresponding page. Bit ordering that equalizes bit-reading numbers according to pages to {2, 2, 3} is not limited to the bit ordering of FIG. 2. For example, the following Table 1 shows other examples of bit ordering that can achieve these characteristics.

TABLE 1

| | E | P1 | P2 | P3 | P4 | P5 | P6 | P7 |
|---|---|---|---|---|---|---|---|---|
| Sample 1 | 000 | 010 | 011 | 111 | 110 | 100 | 101 | 001 |
| Sample 2 | 100 | 110 | 111 | 011 | 010 | 000 | 001 | 101 |

Referring to Table 1, in both Sample 1 and Sample 2, at least one bit “0” is assigned to an erased state, and bit-reading numbers according to pages are equalized to {2, 2, 3}. Samples 1 and 2 are examples, and bit orderings that equalize bit-reading numbers according to pages to {2, 2, 3} may be performed by using a combination of other logical values. Also, like the bit ordering that equalizes bit-reading numbers of the first through third pages page 1 through page 3 to {2, 2, 3}, bit ordering that equalizes bit-reading numbers according to pages to {2, 3, 2} or {3, 2, 2} may have substantially the same effect even in the method of FIG. 1.

Bit ordering that equalizes bit-reading numbers according to pages to {2, 3, 2} or {3, 2, 2} may reduce a maximum number of bit errors, thereby making it easy to implement ECC hardware and software, and reduce overhead of parity bits.

TABLE 2

| | E | P1 | P2 | P3 | P4 | P5 | P6 | P7 |
|---|---|---|---|---|---|---|---|---|
| Sample 1 | 101 | 001 | 011 | 010 | 000 | 100 | 110 | 111 |
| Sample 2 | 000 | 001 | 011 | 111 | 101 | 100 | 110 | 010 |
| Sample 3 | 100 | 101 | 111 | 011 | 001 | 000 | 010 | 110 |

Table 2 shows a bit ordering that equalizes numbers of times first through third pages page 1 through page 3 are read out to {2, 3, 2}. Referring to Table 2, in all of Samples 1 through 3, at least one bit “0” is assigned to an erased state. When using the bit orderings of Sample 1 through Sample 3, because a bit-reading number of second page page 2 is the highest, a maximum number of bit errors is 6. Accordingly, because an ECC condition may be set to correct 6 bit errors in second page page 2, these bit orderings may achieve substantially the same effect as that of FIG. 2.

TABLE 3

| | E | P1 | P2 | P3 | P4 | P5 | P6 | P7 |
|---|---|---|---|---|---|---|---|---|
| Sample 1 | 011 | 001 | 101 | 100 | 000 | 010 | 110 | 111 |
| Sample 2 | 000 | 001 | 101 | 111 | 011 | 010 | 110 | 100 |
| Sample 3 | 100 | 101 | 001 | 011 | 111 | 110 | 010 | 000 |

Table 3 shows bit ordering that equalizes numbers of times first through third pages page 1 through page 3 are read out to {3, 2, 2}. Referring to Table 3, in all of Samples 1 through 3, at least one bit “0” is assigned to an erased state. When using the bit orderings of Sample 1 through Sample 3, a bit-reading number of first page page 1 is 3, which is the highest. Accordingly, an ECC condition needs to be set to correct 6 bit errors in first page page 1.

The bit orderings of Table 2 and Table 3 are examples and can be modified in alternative embodiments. For example, bit orderings that equalize bit-reading numbers according to pages to {2, 3, 2} and {3, 2, 2} through a combination of other logical values may be performed in various ways.

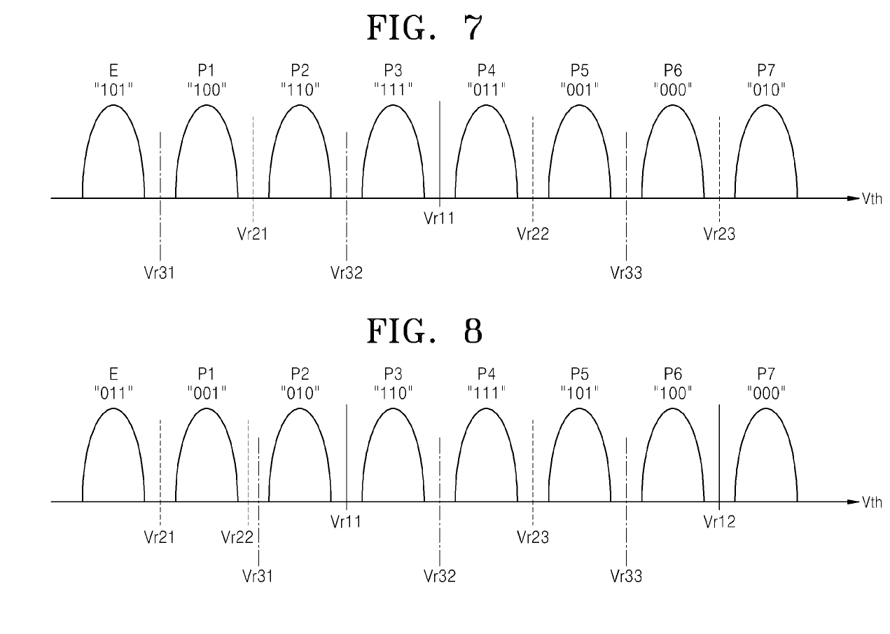

FIG. 7 is a diagram illustrating another example bit ordering that can be used for 3-bit multi-level cells in the method of FIG. 1.

Referring to FIG. 7, logical values are respectively assigned to states E and P1 through P7 of the 3-bit multi-level cell according to bit ordering of “101”, “100”, “110”, “111”, “011”, “001”, “000”, and “010”. The logical value “101” is assigned to an erased state E of the 3-bit multi-level cell, and the other logical values are assigned to programmed states P1 through P7. The bit ordering equalizes bit-reading numbers of first through third pages page 1 through page 3 to {1, 3, 3} such that a total number obtained by summing the bit-reading numbers according to pages is 7. That is, the bit ordering of FIG. 7 performs equalization such that a bit-reading number of first page page 1 is minimized to 1 and a difference between bit-reading numbers of second page page 2 and third page page 3 is 0, unlike the bit ordering of FIG. 1.

In detail, LSBs of data stored in the 3-bit multi-level cell in first page page 1 are read out by reading a region between programmed states P3 and P4 with a read-out voltage Vr11. CSBs of the data stored in the 3-bit multi-level cell in second page page 2 is read out by reading a region between programmed states P1 and P2 with a read-out voltage Vr21, reading a region between programmed states P4 and P5 with a read-out voltage Vr22, and reading a region between programmed states P6 and P7 with a read-out voltage Vr23. MSBs of the data stored in the 3-bit multi-level cell in third page page 3 is read out by reading a region between erased state E and programmed state P1 with a read-out voltage Vr31, reading a region between programmed states P2 and P3 with a read-out voltage Vr32, and a region between programmed states P5 and P6 with a read-out voltage Vr33.

According to the bit ordering, 2 types of bit errors can occur in first page page 1, 6 types of bit errors can occur in second page page 2, and 6 types of bit errors can occur in third page page 3 during a bit reading operation (see FIGS. 4 and 6). Accordingly, as in the bit ordering of FIG. 2, a maximum number of bit errors may be reduced, thereby reducing overhead due to ECC.

TABLE 4

| | E | P1 | P2 | P3 | P4 | P5 | P6 | P7 |
|---|---|---|---|---|---|---|---|---|
| Sample 1 | 110 | 100 | 101 | 111 | 011 | 010 | 000 | 001 |
| Sample 2 | 001 | 000 | 010 | 011 | 111 | 101 | 100 | 110 |
| Sample 3 | 010 | 000 | 001 | 011 | 111 | 110 | 100 | 101 |

Referring to Table 4, in all of Samples 1 through 3, at least one bit “0” is assigned to an erased state, and bit-reading numbers according to pages are equalized to {1, 3, 3}. Samples 1 through 3 are examples, and bit ordering that equalizes bit-reading numbers according to pages to {1, 3, 3} through a combination of other logical values may be performed in various ways.

Also, like the bit ordering that equalizes bit-reading numbers of first through third pages page 1 through page 3 to {1, 3, 3}, even when using bit ordering that equalizes bit-reading numbers according to pages to {3, 1, 3} or {3, 3, 1}, substantially the same effect may be achieved. Such bit ordering may be performed through various combinations of logical values.

FIG. 8 is a diagram illustrating another example bit ordering that can be used for 3-bit multi-level cells in the method of FIG. 1.

Referring to FIG. 8, logical values are respectively assigned to states E and P1 through P7 of the 3-bit multi-level cell according to bit ordering of “011”, “001”, “010”, “110”, “111”, “101”, “100”, and “000”. The logical value “011” is assigned to an erased state E of the 3-bit multi-level cell, and the other logical values are assigned to programmed states P1 through P7. However, the bit ordering is an example when a bit-reading number greater than a minimum bit-reading number is needed, unlike the bit ordering of FIGS. 1 and 7. That is, the bit ordering performs equalization such that a total number obtained by summing bit-reading numbers according to pages is 8 and bit-reading numbers of first through third pages page1 through page 3 are equalized to {2, 3, 3}.

LSBs of data stored in the 3-bit multi-level cell in first page page 1 are read out by reading a region between programmed states P2 and P3 with a read-out voltage Vr11 and reading a region between programmed states P6 and P7 with a read-out voltage Vr12. CSBs of the data stored in the 3-bit multi-level cell in second page page 2 are read out by reading a region between erased state E and programmed state P1 with a read-out voltage Vr21, reading a region between programmed states P1 and P2 with a read-out voltage Vr22, and reading a region between programmed states P4 and P5 with a read-out voltage Vr23. MSBs of the data stored in the 3-bit multi-level cell in third page page 3 are read out by reading a region between programmed states P1 and P2 with a read-out voltage Vr31, reading a region between programmed states P3 and P4 with a read-out voltage Vr32, and reading a region between programmed states P5 and P6 with a read-out voltage Vr33.

When using the bit ordering of FIG. 8, 4 bit errors are generated in first page page 1, 6 types of bit errors may occur in second page page 2, and 6 types of bit errors may occur in third page page 3 during a bit reading operation (see FIGS. 4 and 6). Accordingly, like in the bit ordering of FIGS. 2 and 7, a maximum number of bit errors may be reduced to 6, thereby reducing overhead due to error correction. Bit ordering that equalizes bit-reading numbers according to pages to {2, 3, 3} is not limited to the bit ordering of FIG. 7. Bit ordering that equalizes bit-reading numbers according to pages to {2, 3, 3} through a combination of logical values may be performed in various ways.

Also, like the bit ordering that equalizes bit-reading numbers of first through third pages page 1 through page 3 to {2, 3, 3}, overhead due to error correction may be reduced even where bit ordering that equalizes bit-reading numbers according to pages to {3, 2, 3}, and {3, 3, 2} is used. For example, bit ordering that equalizes bit-reading numbers according to pages to {3, 2, 3} may be “101”, “001”, “100”, “110”, “111”, “011”, “010”, and “000”. Alternatively, bit ordering that equalizes bit-reading numbers according to pages to {3, 3, 2} may be “110”, “010”, “100”, “101”, “111”, “011”, “001”, and “000”. Bit ordering that equalizes bit-reading numbers according to pages to {3, 2, 3} or {3, 3, 2} may be performed in various ways through various combinations of logical values.

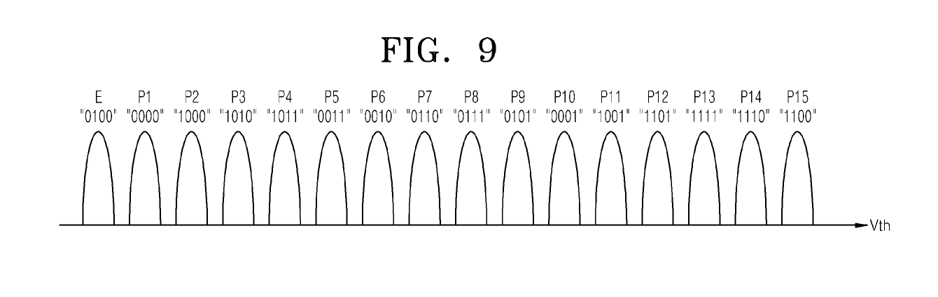

FIG. 9 is a diagram illustrating an example bit ordering that can be used for 4-bit multi-level cells in the method of FIG. 1.

Referring to FIG. 9, logical values are respectively assigned to states E and P1 through P15 of the 4-bit multi-level cell according to bit ordering of “0100”, “0000”, “1000”, “1010”, “1011”, “0011”, “0010”, “0110”, “0111”, “0101”, “0001”, “1001”, “1101”, “1111”, “1110”, and “1110”. The logical value “0100” is assigned to an erased state E of the 4-bit multi-level cell, and the other logical values are assigned to programmed states P1 through P15.

Bits of the logical values representing 4-bit data may be programmed into the 4-bit multi-level cell. For example, 4-bit data “0000” is programmed into the 4-bit multi-level cell having a threshold value range corresponding to programmed state P1. As a result, the 4-bit data is stored in the 4-bit multi-level cell according to the bit ordering.

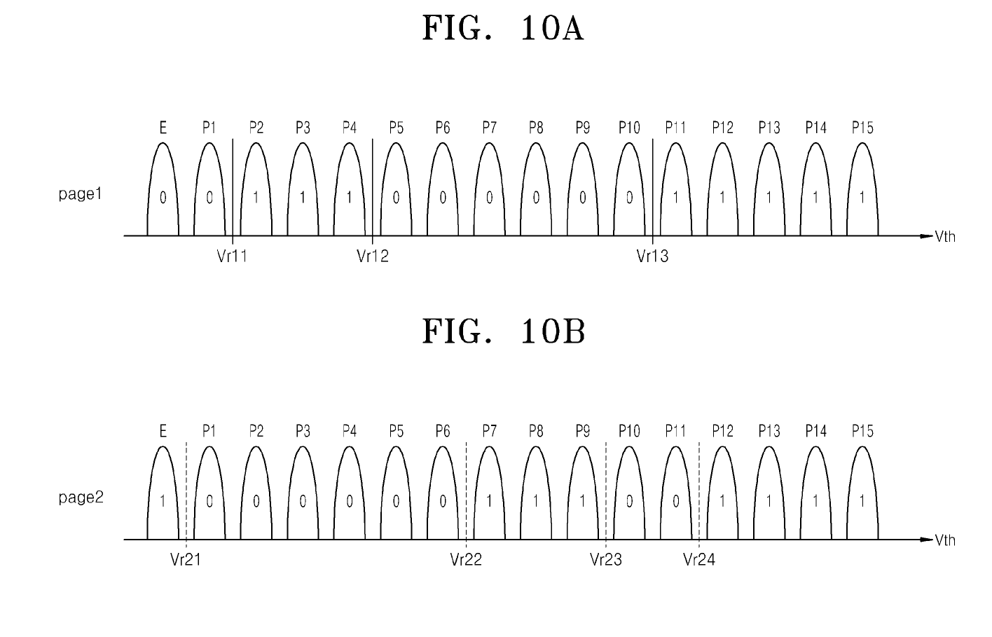

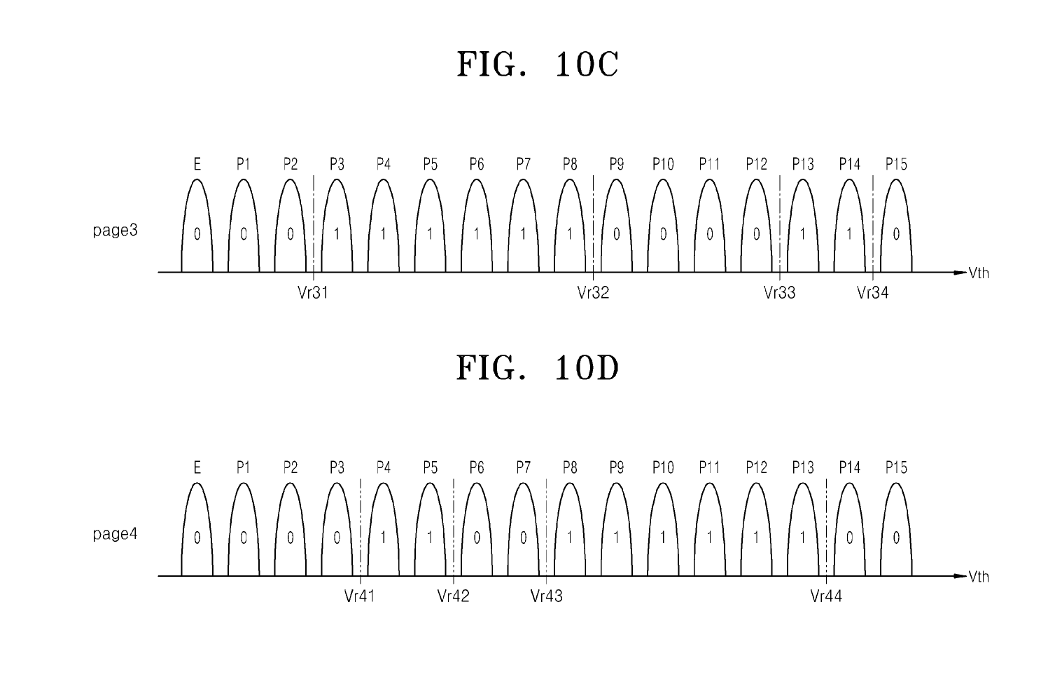

FIGS. 10A through 10D are diagrams illustrating operations for reading data stored in the 4-bit multi-level cells using the bit ordering of FIG. 9.

Referring to FIGS. 10A through 10D, LSBs through MSBs of data stored in the 4-bit multi-level cell corresponding to states of the 4-bit multi-level cell are in different pages. That is, the LSB, CSB1, CSB2, and MSB are located in first through fourth pages page 1 through page 4, respectively.

Referring to FIG. 10A, the LSBs 0, 0, 1, 1, 1, 0, 0, 0, 0, 0, 0, 1, 1, 1, 1, and 1 of the data stored in the 4-bit multi-level cell in first page page 1 are read out through 3 bit reading operations. In particular, the LSBs are read out by reading a region between programmed states P1 and P2 with a read-out voltage Vr11, reading a region between programmed states P4 and P5 with a read-out voltage Vr12, and reading a region between programmed states P10 and P11 with a read-out voltage Vr13.

Referring to FIG. 10B, the CSB1s 1, 0, 0, 0, 0, 0, 0, 1, 1, 1, 0, 0, 1, 1, 1, and 1 of the data stored in the 4-bit multi-level cell in second page page 2 are read out through 4 bit reading operations. In particular, the CSB1s are read out by reading a region between erased state E and programmed state P1 with a read-out voltage Vr21, reading a region between programmed states P6 and P7 with a read-out voltage Vr22, reading a region between programmed states P9 and P10 with a read-out voltage Vr23, and reading a region between programmed states P11 and P12 with a read-out voltage Vr24.

Referring to FIG. 10C, the CSB2s 0, 0, 0, 1, 1, 1, 1, 1, 1, 0, 0, 0, 0, 1, 1, and 0 of the data stored in the 4-bit multi-level cell in third page page 3 are read out through 4 bit reading operations. In particular, the CSB2s are read out by reading a region between programmed states P2 and P3 with a read-out voltage Vr31, reading a region between programmed states P8 and P9 with a read-out voltage Vr32, reading a region between programmed states P12 and P13 with a read-out voltage Vr33, and reading a region between programmed states P14 and P15 with a read-out voltage Vr34.

Referring to FIG. 10D, the MSBs 0, 0, 0, 0, 1, 1, 0, 0, 1, 1, 1, 1, 1, 1, 0, and 0 of the data stored in the 4-bit multi-level cell in fourth page page 4 are read out through 4 bit reading operations. In particular, the MSBs are read out by reading a region between programmed states P3 and P4 with a read-out voltage Vr41, reading a region between programmed states P5 and P6 with a read-out voltage Vr42, reading a region between programmed states P7 and P8 with a read-out voltage Vr43, and reading a region between programmed states P13 and P14 with a read-out voltage Vr44.

As such, the bit ordering of FIG. 9 performs equalization such that a total number obtained by summing bit-reading numbers according to pages is minimized to 15 and a difference between bit-reading numbers of the first through fourth pages page 1 through page 4 is 0 or 1. That is, the bit ordering performs equalization such that a difference between bit-reading numbers of first page page 1 and the other pages, namely, the second through fourth pages Page 2 through Page 4 is 1, and differences between bit-reading numbers of the other pages, namely, the second through fourth pages Page 2 through Page 4, are the same.

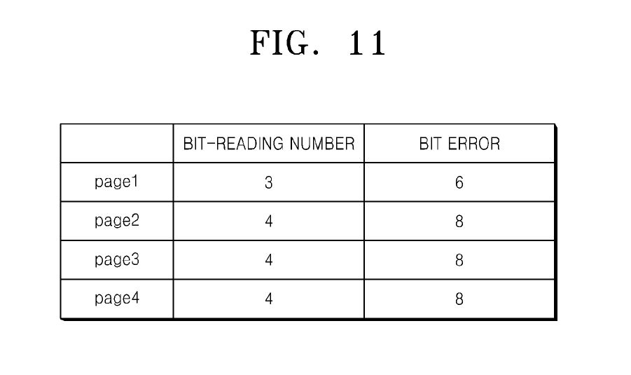

FIG. 11 is a table illustrating bit errors and bit-reading numbers in pages of the 4-bit multi-level cells read by the operation of FIGS. 10A through 10D. More specifically, FIG. 11 shows the number of different types of bit errors that can occur when reading different pages of the 4-bit multi-level cells, and it also shows the number of bit reading operations performed when reading the different pages.

Referring to FIG. 11, when using the bit ordering of FIG. 9, bit-reading numbers according to pages are equalized such that the bit-reading numbers in first page page 1, second page page 2, and third page page 3 are 3, 4, 4, and 4, respectively, and thus data stored in the 4-bit multi-level cell is read out. Because the bit errors and the bit-reading number are proportional to each other (see, FIG. 4), 6 types of bit errors may occur in first page page 1, 8 types of bit errors may occur in second page page 2, 8 types of bit errors may occur in third page page 3, and 8 types of bit errors may occur in fourth page page 4 during a bit reading operation.

When using gray coding, because logical values are assigned to states E and P1 through P15 of the 4-bit multi-level cell according to bit ordering “1111”, “1110”, “1100”, “1101”, “1001”, “1000”, “1010”, “1011”, “0011”, “0010”, “0000”, “0100”, “0110”, “0111”, “0101”, and “0001”, bit-reading numbers increase twofold toward a higher page, and thus, 16 types of bit errors may occur in fourth page page 4, which is an MSB page. When using the bit ordering of FIG. 9, because a maximum number of bit errors is reduced to 8, overhead due to error correction may be reduced and ECC hardware and software may be easily implemented.

Bit ordering that equalizes bit-reading numbers according to pages to {3, 4, 4, 4} is not limited to the bit ordering of FIG. 9. Bit ordering such as that shown in Table 5 also equalizes bit-reading numbers according to pages to {3, 4, 4, 4}.

TABLE 5

| | E | P1 | P2 | P3 | P4 | P5 | P6 | P7 | P8 | P9 | P10 | P11 | P12 | P13 | P14 | P15 |
|---|---|---|---|---|---|---|---|---|---|---|---|---|---|---|---|---|
| Sample 1 | 1011 | 1111 | 0111 | 0101 | 0100 | 1100 | 1101 | 1001 | 1000 | 1010 | 1110 | 0110 | 0010 | 0000 | 0001 | 0011 |
| Sample 2 | 1100 | 1110 | 1111 | 1101 | 1001 | 0001 | 0101 | 0111 | 0110 | 0010 | 0011 | 1011 | 1010 | 1000 | 0000 | 0100 |
| Sample 3 | 0011 | 0001 | 0000 | 0010 | 0110 | 1110 | 1010 | 1000 | 1001 | 1101 | 1100 | 0100 | 0101 | 0111 | 1111 | 1011 |

Also, like the bit ordering that equalizes bit-reading numbers of the first through fourth pages page 1 through page 4 to {3, 4, 4, 4}, substantially the same effect may be achieved even when using bit ordering that equalizes bit-reading numbers according to pages to {4, 3, 4, 4}, {4, 4, 3, 4}, or {4, 4, 4, 3}.

Table 6 shows an example of bit ordering that equalizes bit-reading numbers according to pages to {4, 3, 4, 4}.

TABLE 6

| | E | P1 | P2 | P3 | P4 | P5 | P6 | P7 | P8 | P9 | P10 | P11 | P12 | P13 | P14 | P15 |
|---|---|---|---|---|---|---|---|---|---|---|---|---|---|---|---|---|
| Sample 1 | 1000 | 0000 | 0100 | 0110 | 0111 | 0101 | 0010 | 1010 | 1011 | 1001 | 0001 | 0101 | 1101 | 1111 | 1110 | 1100 |
| Sample 2 | 0111 | 1111 | 1011 | 1001 | 1000 | 1100 | 1101 | 0101 | 0100 | 0110 | 1110 | 1010 | 0010 | 0000 | 0001 | 0011 |
| Sample 3 | 1100 | 1110 | 1111 | 1101 | 0101 | 0001 | 1001 | 1011 | 1010 | 0010 | 0011 | 0111 | 0110 | 0100 | 0000 | 1000 |
| Sample 4 | 0011 | 0001 | 0000 | 0010 | 1010 | 1110 | 0110 | 0100 | 0101 | 1101 | 1100 | 1000 | 1001 | 1011 | 1111 | 0111 |

Table 7 shows an example of bit ordering that equalizes bit-reading numbers according to pages to {4, 4, 3, 4}.

TABLE 7

| | E | P1 | P2 | P3 | P4 | P5 | P6 | P7 | P8 | P9 | P10 | P11 | P12 | P13 | P14 | P15 |
|---|---|---|---|---|---|---|---|---|---|---|---|---|---|---|---|---|
| Sample 1 | 1000 | 0000 | 0010 | 0110 | 0111 | 0101 | 0100 | 1100 | 1101 | 1001 | 0001 | 0011 | 1011 | 1111 | 1110 | 1010 |
| Sample 2 | 0111 | 1111 | 1101 | 1001 | 1000 | 1010 | 1011 | 0011 | 0010 | 0110 | 1110 | 1100 | 0100 | 0000 | 0001 | 0101 |
| Sample 3 | 1010 | 1110 | 1111 | 1011 | 0011 | 0001 | 1001 | 1101 | 1100 | 0100 | 0101 | 0111 | 0110 | 0010 | 0000 | 1000 |
| Sample 4 | 0101 | 0001 | 0000 | 0100 | 1100 | 1110 | 0110 | 0010 | 0011 | 1011 | 1010 | 1000 | 1001 | 1101 | 1111 | 0111 |

Table 8 shows an example of bit ordering that equalizes bit-reading numbers according to pages to {4, 4, 4, 3}.

TABLE 8

| | E | P1 | P2 | P3 | P4 | P5 | P6 | P7 | P8 | P9 | P10 | P11 | P12 | P13 | P14 | P15 |
|---|---|---|---|---|---|---|---|---|---|---|---|---|---|---|---|---|
| Sample 1 | 1000 | 0000 | 0001 | 0101 | 0111 | 0110 | 0100 | 1100 | 1110 | 1010 | 0010 | 0011 | 1011 | 1111 | 1101 | 1001 |
| Sample 2 | 0111 | 1111 | 1110 | 1010 | 1000 | 1001 | 1011 | 0011 | 0001 | 0101 | 1101 | 1100 | 0100 | 0000 | 0010 | 0110 |
| Sample 3 | 1001 | 1101 | 1111 | 1011 | 0011 | 0010 | 1010 | 1110 | 1100 | 0100 | 0110 | 0111 | 0101 | 0001 | 0000 | 1000 |
| Sample 4 | 0110 | 0010 | 0000 | 0100 | 1100 | 1101 | 0101 | 0001 | 0011 | 1011 | 1001 | 1000 | 1010 | 1110 | 1111 | 0111 |

In the bit orderings of Table, 6, Table 7, and Table 8, at least one bit “0” is assigned to an erased state. Also, a maximum number of bit errors may be reduced to 8 or less, thereby reducing overhead due to error correction. Bit ordering that equalizes bit-reading numbers according to pages {3, 4, 4, 4}, {4, 3, 4, 4}, {4, 4, 3, 4}, or {4, 4, 4, 3} may be performed in various ways through combinations of logical values.

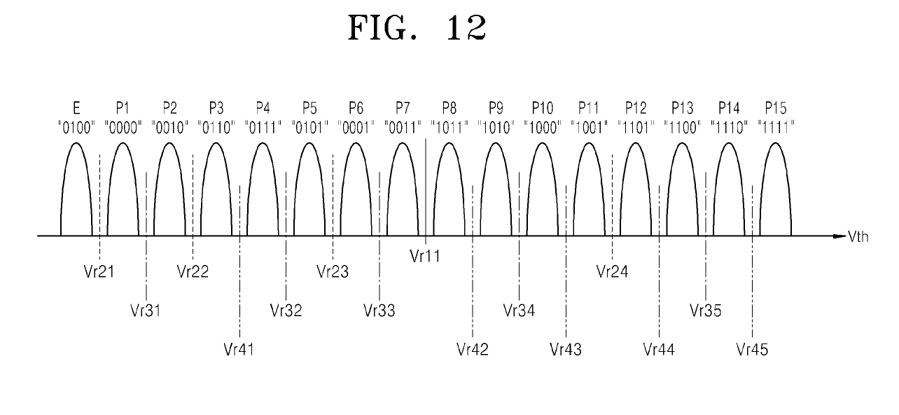

FIG. 12 is a diagram illustrating another example bit ordering that can be used for 4-bit multi-level cells in the method of FIG. 1.

Referring to FIG. 12, logical values are assigned to states E and P1 through P15 of the 4-bit multi-level cell according to bit ordering of “0100”, “0000”, “0010”, “0110”, “0111”, “0101”, “0001”, “0011”, “1011”, “1010”, “1000”, “1001”, “1101”, “1100”, “1110”, and “1111”. The logical value “0100” is assigned to erased state E of the 4-bit multi-level cell, and the other logical values are assigned to programmed states P1 through P15.

The bit ordering equalizes bit-reading numbers according to pages such that a total number obtained by summing bit-reading numbers according to pages is 15 and bit-reading numbers of first through fourth pages page 1 through page 4 are equalized to {1, 4, 5, 5}. The bit ordering of FIG. 12 performs equalization such that a bit-reading number of first page page 1 is minimized to 1, a difference between bit-reading numbers of second page page 2 and third page page 3 is 1, a difference between bit-reading numbers of second page page 2 and fourth page page 4 is 1, and a difference between third page page 3 and fourth page page 4 is 0, unlike the bit ordering of FIG. 9. An operation of reading data would be understood from FIGS. 10A through 10D, and thus, a further explanation thereof will not be provided. When using the bit ordering, because 10 types of bit errors may occur in third page page 3 and fourth page page 4 during a bit reading operation, a maximum number of bit errors may be reduced, thereby reducing overhead due to error correction.

Another bit ordering that equalizes bit-reading numbers of first through fourth pages page 1 through page 4 to {1, 4, 5, 5} may be “0000”, “0001”, “0011”, “0010”, “0110”, “0111”, “0101”, “0100”, “1100”, “1110”, “1010”, “1000”, “1001”, “1101”, “1111”, and “1011”. Bit ordering that equalizes bit-reading numbers according to pages {1, 4, 5, 5}, {4, 1, 5, 5}, {4, 5, 1, 5}, {4, 5, 5, 1}, or {5, 5, 4, 1} can be performed in various alternative ways through combinations of logical values.

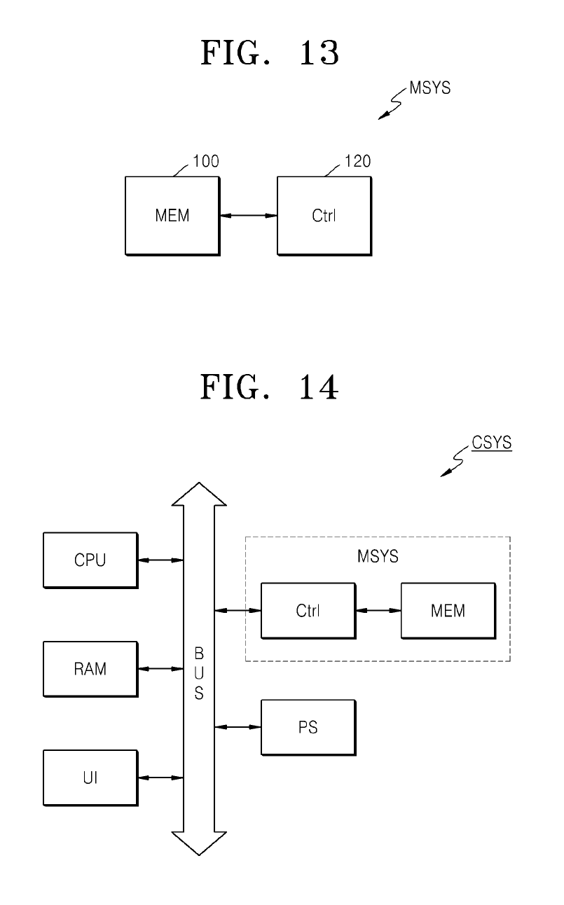

FIG. 13 is a block diagram of a memory system MSYS comprising a nonvolatile memory device 100 that stores data according to the method of FIG. 1 according to an embodiment of the inentive concept.

Referring to FIG. 13, memory system MSYS comprises nonvolatile memory device 100 and a memory controller 120. Nonvolatile memory device 100 serves as a storage medium for memory system MSYS, and it stores data according to the method of FIG. 1. The use of this method can reduce a maximum number of bit errors generated when data is read out from the n-bit multi-level cells, which can reduce overhead due to error correction. In addition, the use of this method allows hardware and software of an ECC circuit in memory controller 120 to be readily implemented. These and other potential benefits can also be experienced in devices or systems that may incorporate memory system MSYS, such as those illustrated in FIGS. 14 through 17.

Nonvolatile memory device 100 can comprise, for example, a NAND flash memory comprising a plurality of n-bit multi-level cells and having a large storage capacity. Alternatively, nonvolatile memory device 100 can comprise, for example, a phase change random access memory (PRAM), a magnetic random access memory (MRAM), a resistance random access memory (ReRAM), a ferroelectric random access memory (FRAM), or a NOR flash memory.

Memory controller 120 receives data and an address provided from an external host via an interface. Memory controller 120 accesses nonvolatile memory device 100 using the data and the address provided from the external host. Memory controller 120 comprises an ECC circuit.

FIG. 14 is a block diagram illustrating a computing system CSYS comprising memory system MSYS of FIG. 13 according to an embodiment of the inventive concept.

Referring to FIG. 14, computing system CSYS comprises a processor CPU, a user interface UI, and memory system MSYS. These components are electrically connected to each other via a bus BUS. N-bit data (N>1) processed or to be processed by processor CPU is stored in nonvolatile memory device 100 under the control of memory controller 120.

Computing system CSYS further comprises a power supply device PS. Also, where nonvolatile memory device 100 is a flash memory device, computing system CSYS may further comprise a volatile memory device, such as a random access memory (RAM). Where computing system CSYS is a mobile device, it may further comprise a modem, such as a baseband chipset, or a battery for supplying a voltage for operating computing system CSYS. Moreover, computing system CSYS may further comprise various standard components such as an application chipset, a camera image processor (CIS), or a mobile dynamic random access memory (DRAM).

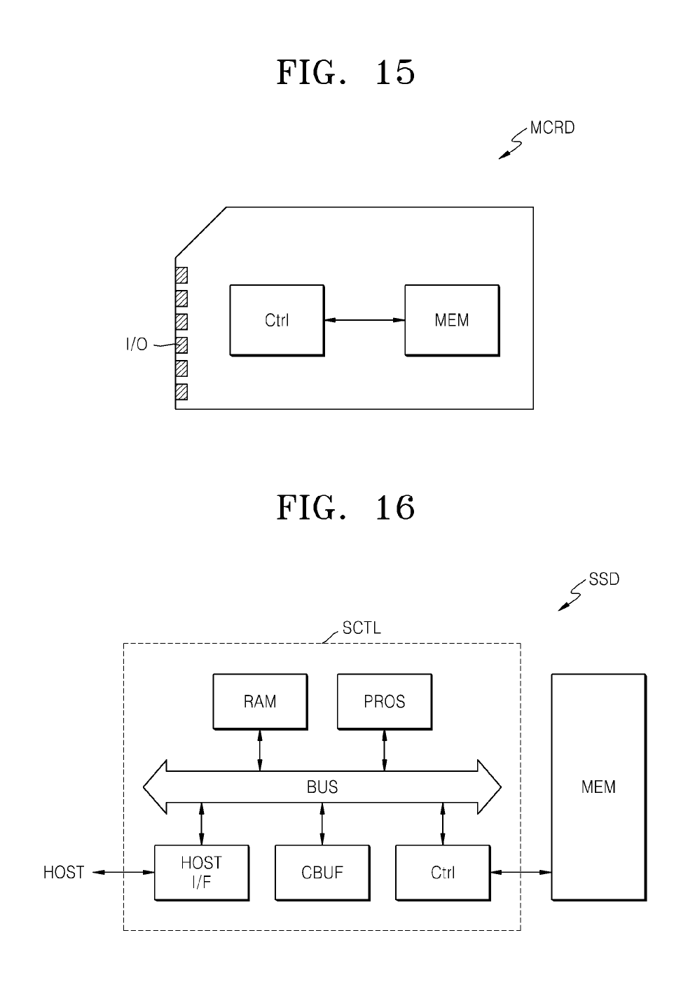

FIG. 15 is a diagram illustrating a memory card MCRD in which data is stored according to the method of FIG. 1 according to an embodiment of the inventive concept. Memory card MCRD of FIG. 15 can take various alternative forms, such as a compact flash card (CFC), a microdrive, a smart media card (SMC), a multimedia card (MMC), a security digital card (SDC), a memory stick, or a universal serial bus (USB) flash memory, for example.

Referring to FIG. 15, memory card MCRD comprises a memory controller Ctrl and a memory device MEM. Memory controller Ctrl controls program and read operations of memory device MEM in response to a request received from an external host via an input/output (I/O) unit. Where memory device MEM is a flash memory device, memory controller Ctrl also controls erase operations of memory device MEM. Memory controller Ctrl of memory card MCRD typically comprises interface units and a RAM that interface with the host and memory device MEM.

FIG. 16 is a block diagram illustrating a solid state drive (SSD) in which data is stored according to the method of FIG. 1 according to an embodiment of the inventive concept.

Referring to FIG. 16, the SSD comprises an SSD controller SCTL and a memory device MEM. SSD controller SCTL comprises a processor PROS, a RAM, a cache buffer (CBUF), and a memory controller Ctrl which are connected to a bus BUS. Processor PROS controls memory controller Ctrl to communicate with memory device MEM in response to a request (e.g., a command, an address, or data) from a host. Processor PROS and memory controller Ctrl of the SSD may constitute, for instance, an ARM processor. Data needed to operate processor PROS may be loaded to the RAM. A host interface HOST I/F receives a request from the host and transmits a response to processor PROS, or it transmits data transmitted from memory device MEM to the host. Host interface HOST I/F may interface with the host via one of various standard interface protocols such as USB, man machine communication (MMC), peripheral interconnect-express (PCI-E), serial advanced technology attachment (SATA), parallel advanced technology attachment (PATA), small computer system interface (SCSI), enhanced small device interface (ESDI), or intelligent drive electronics (IDE), for example.

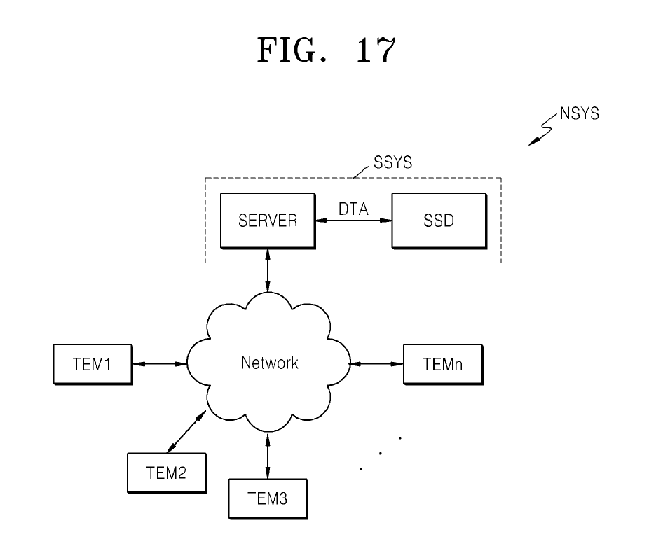

FIG. 17 is a diagram illustrating a server system SSYS comprising the SSD of FIG. 16, and a network system NSYS comprising server system SSYS, according to an embodiment of the inventive concept.

Referring to FIG. 17, network system NSYS comprises server system SSYS and a plurality of terminals TEM1 through TEMn connected to each other via a network. Server system SSYS comprises a server SERVER that processes requests received from terminals TEM1 through TEMn connected to the network. Server system SSYS further comprises the SSD, which stores data corresponding to the requests received from terminals TEM1 through TEMn.

The above-described memory devices and systems can be mounted in various types of packages. For example, they can be mounted in packages having standard configurations such as package on package (PoP), ball grid array (BGA), chip scale package (CSP), plastic leaded chip carrier (PLCC), plastic dual in-line package (PDIP), die in waffle pack, die in wafer form, chip on board (COB), ceramic dual in-line package (CERDIP), plastic metric quad flat pack (MOFP), thin quad flatpack (TOFP), small outline integrated circuit (SOIC), shrink small outline package (SSOP), thin small outline package (TSOP), thin quad flatpack (TQFP), system in package (SIP), multi chip package (MCP), wafer-level fabricated package (WFP), and wafer-level processed stack package (WSP).

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims.

What is claimed is:

1. A method of operating a nonvolatile memory device, comprising:
defining a bit ordering for a plurality of n-bit (n>2) multi-level cells such that bit-reading numbers associated with different pages of the n-bit multi-level cells are substantially equalized, wherein the bit ordering assigns at least one bit “0” to an erased state of the n-bit multi-level cells; and
programming n-bit data into each of the n-bit multi-level cells according to the bit ordering.

2. The method of claim 1, wherein the bit ordering equalizes the bit-reading numbers associated with different pages of the n-bit multi-level cells such that the bit-reading numbers differ from each other by no more than two.

3. The method of claim 1, further comprising reading the n-bit data from the n-bit multi-level cells using read-out voltages corresponding to the bit-reading numbers.

4. The method of claim 1, wherein the bit ordering equalizes the bit-reading numbers associated with a first page corresponding to least significant bit (LSB) data through an n-th page corresponding to most significant bit (MSB) data.

5. The method of claim 4, wherein the bit ordering minimizes a sum of the bit-reading numbers associated with the first through n-th pages.

6. The method of claim 5, wherein the bit ordering equalizes the bit-reading numbers of the first through n-th pages such that a difference between the bit-reading numbers of the first through n-th pages is zero or one.

7. The method of claim 6, wherein n=3 and the bit ordering equalizes the bit-reading numbers of the first through third pages to one of {2, 2, 3}, {2, 3, 2}, and {3, 2, 2}.

8. The method of claim 6, wherein n=4 and the bit ordering equalizes the bit-reading numbers of the first through fourth pages to one of {3, 4, 4, 4}, {4, 3, 4, 4}, {4, 4, 3, 4}, and {4, 4, 4, 3}.

9. The method of claim 5, wherein the bit ordering equalizes the bit-reading numbers of the first through n-th pages such that the bit-reading number of one page of the first through n-th pages is fixed to 1 and a difference between the bit-reading numbers of the other pages is 0 or 1.

10. The method of claim 9, wherein n=3 and the bit ordering equalizes the bit-reading numbers of the first through third pages to one of {1, 3, 3}, {3, 1, 3}, and {3, 3, 1}.

11. The method of claim 9, wherein n=4 and the bit ordering equalizes the bit-reading numbers of the first through fourth pages to one of {1, 4, 5, 5}, {4, 1, 5, 5}, {4, 5, 1, 5}, {4, 5, 5, 1}, and {5, 5, 4, 1}.

12. The method of claim 4, wherein the bit ordering equalizes the bit-reading numbers of the first through n-th pages such that a difference between the bit-reading numbers of the first through n-th pages is 0 or 1.

13. The method of claim 12, wherein when n=3 and the bit ordering equalizes the bit-reading numbers of the first through third pages to one of {2, 3, 3}, {3, 2, 3}, and {3, 3, 2}.

14. A memory system, comprising:
a nonvolatile memory device comprising a plurality of n-bit (n>2) multi-level cells;
a controller configured to program n-bit data into the n-bit multi-level cells according to a bit ordering in which bit-reading numbers associated with different pages of the n-bit multi-level cells are substantially equalized and in which at least one bit “0” is assigned to an erased state of the n-bit multi-level cells.

15. The memory system of claim 14, wherein the nonvolatile memory device comprises a NAND flash memory cells, and the pages correspond to rows of the NAND flash memory cells.

16. The memory system of claim 14, wherein the bit ordering equalizes the bit-reading numbers associated with different pages of the n-bit multi-level cells such that the bit-reading numbers differ from each other by no more than two.

17. The memory system of claim 14, wherein the bit ordering equalizes the bit-reading numbers associated with a first page corresponding to least significant bit (LSB) data through an n-th page corresponding to most significant bit (MSB) data.

18. The memory system of claim 17, wherein the bit ordering minimizes a sum of the bit-reading numbers associated with the first through n-th pages.

19. The memory system of claim 18, wherein the bit ordering equalizes the bit-reading numbers of the first through n-th pages such that a difference between the bit-reading numbers of the first through n-th pages is zero or one.

20. The memory system of claim 18, wherein the bit ordering equalizes the bit-reading numbers of the first through n-th pages such that the bit-reading number of one page of the first through n-th pages is fixed to 1 and a difference between the bit-reading numbers of the other pages is 0 or 1.
